(19) United States
(12) Patent Application Publication
(10) Pub. No.: US 2025/0334265 A1
(43) Pub. Date: Oct. 30, 2025

(54) COMBUSTOR AND AMMONIA ENGINE SYSTEM

(71) Applicant: KABUSHIKI KAISHA TOYOTA JIDOSHOKKI, Kariya-shi, Aichi-ken (JP)

(72) Inventor: Hideaki SUZUKI, Kariya-shi (JP)

(73) Assignee: KABUSHIKI KAISHA TOYOTA JIDOSHOKKI, Kariya-shi, Aichi-ken (JP)

(21) Appl. No.: 18/867,305

(22) PCT Filed: May 23, 2023
(86) PCT No.: PCT/JP2023/019065

§ 371 Date: Nov. 19, 2024

(30) Foreign Application Priority Data
May 31, 2022 (JP) 2022-088755

(51) Int. Cl. F23D 14/02; C01B 3/04; F23C 9/00; F23Q 3/00

(52) U.S. Cl. CPC F23D 14/02; C01B 3/047; F23C 9/00; F23Q 3/008; F23C 2202/10

(57) ABSTRACT

A combustor (40) includes a housing (41) having an open first end and a closed second end (41b), an inlet that introduces fuel and oxidizing gas into the housing (41) such that a tubular flow (F1) is generated in the housing (41), an ignition plug (44) disposed at the second end (41b), and an ignition unit that generates a spark (P1) between a positive electrode (45) and a negative electrode (46). The positive electrode (45) and the negative electrode (46) are each located at a position where a distance (L1) between them is shorter than a distance (L2) between the positive electrode (45) and an inner circumferential surface (41d) of the housing (41) such that a flame (P2) generated between the positive electrode (45) and the negative electrode (46) by the spark (P1) is formed only in a negative pressure region (A1).

### TECHNICAL FIELD

The present disclosure relates to a combustor and an ammonia engine system.

### BACKGROUND ART

Patent Literature 1 discloses a combustor that includes a cylindrical housing, an inlet, and an ignition plug. The housing has a first end, which is open, and a second end, which is closed. Fuel mixed with oxidizing gas and combustion gas generated by combustion of the fuel flow through the housing. The inlet introduces the fuel and oxidizing gas into the housing such that a tubular flow is generated in the housing. The ignition plug is disposed at the second end of the housing. When the combustion gas is ignited by the ignition plug, a flame is generated in the housing. The combustion gas is discharged out of the first end of the housing.

### CITATION LIST

### Patent Literature

Patent Literature 1: Japanese Laid-Open Patent Publication No. 2004-93114

### SUMMARY OF INVENTION

### Technical Problem

To discharge a large amount of combustion gas from the combustor at an earlier

stage, it is desired to generate a large amount of combustion gas in the combustor shortly after the flame is produced.

### Solution to Problem

A combustor according to an aspect of the present disclosure includes a cylindrical housing having a first end and a second end. The first end is open and the second end is closed. The housing is configured such that fuel mixed with oxidizing gas and combustion gas generated by combustion of the fuel flow through the housing. The combustor further includes at least one inlet configured to introduce the fuel and the oxidizing gas into the housing such that a tubular flow is generated in the housing. The inlet is configured such that the tubular flow generates a negative pressure region in part of the housing. The combustor further includes an ignition plug disposed at the second end of the housing and including a positive electrode and a negative electrode, and an ignition unit configured to generate a spark between the positive electrode and the negative electrode. The positive electrode and the negative electrode are each located at a position where a distance between the positive electrode and the negative electrode is shorter than a distance between the positive electrode and an inner circumferential surface of the housing such that a flame generated between the positive electrode and the negative electrode by the spark is formed only in the negative pressure region.

An ammonia engine system according to an aspect of the present disclosure includes the above-described combustor, a reforming catalyst configured to be warmed up by combustion gas, and an ammonia engine configured to be supplied with hydrogen that is discharged out of the reforming catalyst. A distance between the positive electrode and the negative electrode allows the ammonia engine to be started within a start time required for a vehicle on which the ammonia engine system is mounted.

### BRIEF DESCRIPTION OF DRAWINGS

FIG. 1 is a schematic diagram of an ammonia engine system according to an embodiment.

FIG. 2 is a schematic diagram illustrating the combustor, ignition plug, and ignition unit of the ammonia engine system shown in FIG. 1.

FIG. 3 is a cross-sectional view taken along line 3-3 of FIG. 2.

FIG. 4 is a cross-sectional view taken along line 4-4 of FIG. 3.

FIG. 5 is an enlarged cross-sectional view illustrating part of the combustor shown in FIG. 2.

FIG. 6 is a graph illustrating the relationship between the position of the housing of the combustor shown in FIG. 2 in the radial direction and the pressure in the housing.

FIG. 7 is a graph showing the time required to start the ammonia engines of Example and Comparative Example.

### DESCRIPTION OF EMBODIMENTS

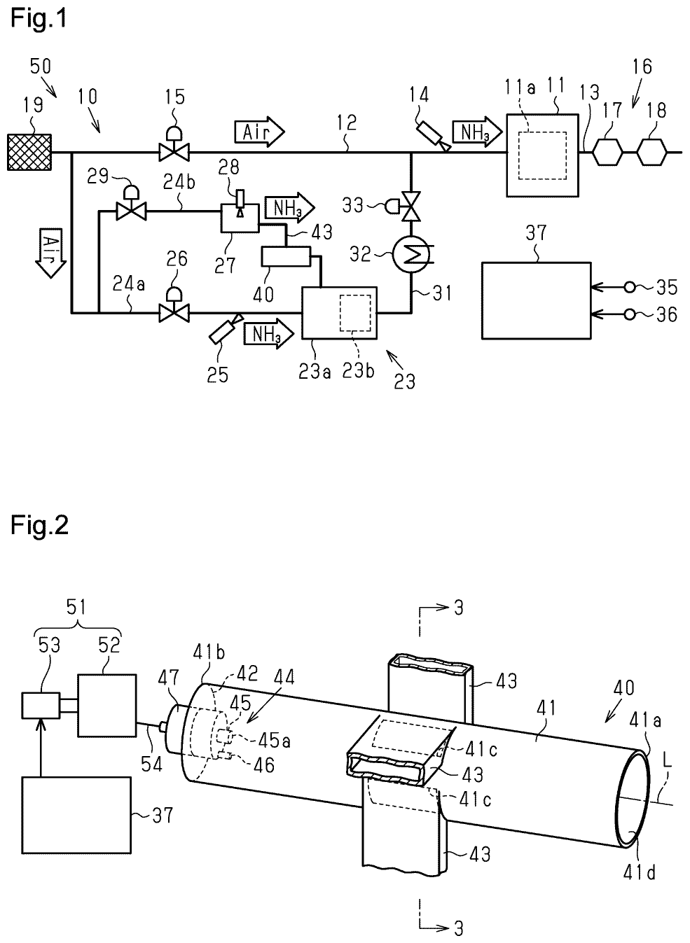

A combustor and an ammonia engine system according to an embodiment will now be described with reference to FIGS. 1 to 7.

### Schematic Configuration of Ammonia Engine System

As shown in FIG. 1, an ammonia engine system 10 includes an ammonia engine 11. The ammonia engine system 10 of the present embodiment is mounted on an engine-powered vehicle 50. The ammonia engine 11 uses ammonia (NH₃) gas as fuel. The ammonia engine 11 includes a combustion chamber 11a.

The ammonia engine system 10 includes an intake passage 12, an air cleaner 19, a main injector 14, and a main throttle valve 15. Air is introduced into the combustion chamber 11a from the intake passage 12. The air cleaner 19 removes foreign matter such as dust and dirt contained in the air. The air cleaner 19 is located at an end of the intake passage 12. The air from which foreign matter has been removed by the air cleaner 19 flows into the intake passage 12.

The main injector 14 is, for example, an electromagnetic injection valve. Ammonia gas is supplied to the main injector 14 from an ammonia gas supply unit (not shown). The main injector 14 supplies the ammonia gas to the intake passage 12 by injecting the ammonia gas into the intake passage 12. The ammonia gas supplied from the main injector 14 to the intake passage 12 is introduced into the combustion chamber 11a together with the air flowing through the intake passage 12.

The main throttle valve 15 is located upstream of a portion of the intake passage 12 to which ammonia gas is supplied from the main injector 14. The main throttle valve 15 is, for example, an electromagnetic flow rate control valve capable of adjusting the opening degree of the intake passage 12.

The ammonia engine system 10 includes an exhaust passage 13 and an exhaust catalyst unit 16. The exhaust gas generated in the combustion chamber 11a is introduced into the exhaust passage 13 from the combustion chamber 11a. The exhaust catalyst unit 16 is located in the exhaust passage 13. The exhaust catalyst unit 16 includes a three-way catalyst 17 and a SCR catalyst 18. The three-way catalyst 17 oxidizes the ammonia gas remaining in the exhaust gas that flows through the exhaust passage 13 to remove the ammonia gas from the exhaust gas. The three-way catalyst 17 is activated by the heat of the exhaust gas. The SCR catalyst 18 is located downstream of the three-way catalyst 17 in the exhaust passage 13. The SCR catalyst 18 is a selective catalytic reduction catalyst. The SCR catalyst 18 reduces nitrogen oxides (NOx) contained in the exhaust gas flowing through the exhaust passage 13 to nitrogen (N₂) using ammonia. Further, the SCR catalyst 18 traps and removes the ammonia that has passed through the three-way catalyst 17.

The ammonia engine system 10 includes a reformer 23. The reformer 23 has a box-shaped accommodation portion 23a in which a space is defined. The accommodation portion 23a includes a reforming catalyst 23b. In other words, the ammonia engine system 10 includes the reforming catalyst 23b. For example, the accommodation portion 23a may include a honeycomb-structured carrier (not shown). The reforming catalyst 23b may be provided in the accommodation portion 23a by applying the reforming catalyst 23b to the carrier. The reforming catalyst 23b functions to decompose ammonia into hydrogen and burn ammonia. The reforming catalyst 23b is, for example, an autothermal reformer (ATR) ammonia reforming catalyst. The reformer 23 generates reformed gas containing hydrogen by reforming ammonia gas using the reforming catalyst 23b.

The ammonia engine system 10 includes a reformed gas passage 31, a cooler 32, and a stop valve 33. One end of the reformed gas passage 31 is connected to the reformer 23. The other end of the reformed gas passage 31 is connected to the intake passage 12 at a position downstream of the main throttle valve 15. The reformed gas generated by the reformer 23 is introduced into the reformed gas passage 31, and the reformed gas is introduced from the reformed gas passage 31 into the intake passage 12.

The cooler 32 cools the reformed gas flowing through the reformed gas passage 31. The cooler 32 cools the reformed gas, for example, by exchanging heat between coolant flowing through the cooler 32 and the reformed gas. The reformed gas cooled by the cooler 32 is introduced into the intake passage 12 through the reformed gas passage 31. This reduces the damage to the intake system components, such as the main throttle valve 15, due to the heat of the reformed gas. As the reformed gas is cooled, the volumetric expansion of the reformed gas is suppressed, making it easier for the gas to flow from the intake passage 12 into the combustion chamber 11a.

The stop valve 33 is located downstream of the cooler 32 in the reformed gas passage 31. The stop valve 33 is, for example, an on-off valve that selectively opens and closes the reformed gas passage 31.

The ammonia engine system 10 includes a first air passage 24a, a first injector 25, and a first throttle valve 26. One end of the first air passage 24a is connected to the intake passage 12 at a position upstream of the main throttle valve 15. The other end of the first air passage 24a is connected to the reformer 23. Some of the air introduced into the intake passage 12 through the air cleaner 19 is introduced into the first air passage 24a. Further, the air is introduced from the first air passage 24a into the reformer 23.

The first injector 25 is, for example, an electromagnetic injection valve. Ammonia gas is supplied to the first injector 25 from the ammonia gas supply unit (not shown). The first injector 25 supplies the ammonia gas to the first air passage 24a by injecting the ammonia gas into the first air passage 24a. The ammonia gas supplied from the first injector 25 to the first air passage 24a is introduced into the reformer 23 together with the air flowing through the first air passage 24a.

The first throttle valve 26 is located upstream of a portion of the first air passage 24a to which ammonia gas is supplied from the first injector 25. The first throttle valve 26 is, for example, an electromagnetic flow rate control valve capable of adjusting the opening degree of the first air passage 24a.

The ammonia engine system 10 includes a second air passage 24b, a chamber 27, a second injector 28, a second throttle valve 29, and a combustor 40. One end of the second air passage 24b is connected to the first air passage 24a on the upstream side of the first throttle valve 26. The other end of the second air passage 24b is connected to the chamber 27. Some of the air flowing through the first air passage 24a is introduced into the second air passage 24b. The chamber 27 has a box-shaped structure, with a space formed inside. Air is introduced from the second air passage 24b into the space inside the chamber 27.

The second injector 28 is, for example, an electromagnetic injection valve. Ammonia gas is supplied to the second injector 28 from the ammonia gas supply unit (not shown). The second injector 28 supplies the ammonia gas to the space in the chamber 27 by injecting the ammonia gas into the space in the chamber 27. The air introduced from the second air passage 24b into the chamber 27 and the ammonia gas supplied from the second injector 28 into the chamber 27 are mixed in the chamber 27. As a result, ammonia gas mixed with air is generated in the chamber 27. In the present embodiment, ammonia gas corresponds to fuel, and air corresponds to oxidizing gas. The ammonia gas mixed with air is introduced into the combustor 40 from the chamber 27.

The second throttle valve 29 is located in the second air passage 24b. The second throttle valve 29 is, for example, an electromagnetic flow rate control valve capable of adjusting the opening degree of the second air passage 24b.

The combustor 40 generates combustion gas by burning ammonia gas as fuel. The combustion gas generated by the combustor 40 is introduced into the reformer 23.

The ammonia engine system 10 includes a temperature sensor 35, an ignition switch 36, and a control unit 37. The temperature sensor 35 detects the temperature of the reformer 23. When the ignition switch 36 is operated by a driver of the vehicle 50, the ignition switch 36 outputs an operation signal to the control unit 37. The control unit 37 includes, for example, a CPU, a RAM, a ROM, an input-output interface, and the like.

The control unit 37 performs various controls based on, for example, a detection value from the temperature sensor 35 and an operation signal from the ignition switch 36. The control unit 37 controls the main injector 14, the main throttle valve 15, the first injector 25, the first throttle valve 26, the second injector 28, the second throttle valve 29, the stop valve 33, and the like.

### Control by Control Unit

The control unit 37 executes startup control to start the ammonia engine 11. The control unit 37 performs the startup control on condition that it is determined that the ignition switch 36 has been turned on based on the operation signal from the ignition switch 36.

In the startup control, the control unit 37 causes the first injector 25 and the second injector 28 to inject ammonia gas. The control unit 37 opens the first throttle valve 26, the second throttle valve 29, and the stop valve 33. Subsequently, in the startup control, the control unit 37 starts the ammonia engine 11 by controlling a starter motor (not shown) to crank the ammonia engine 11. Further, in the startup control, the control unit 37 causes the main injector 14 to inject the ammonia gas and causes the main throttle valve 15 to open.

In the startup control, the control unit 37 determines whether the temperature of the reformer 23 is greater than or equal to a specified temperature based on the detection value from the temperature sensor 35. The specified temperature is a temperature at which ammonia gas can be combusted, and is, for example, approximately 200° C. When determining that the temperature of the reformer 23 is greater than or equal to the specified temperature, the control unit 37 stops injecting the ammonia gas from the second injector 28, and closes the second throttle valve 29. This stops the introduction of the air and ammonia gas supplied from the chamber 27 to the combustor 40. When the combustion of the ammonia gas in the combustor 40 is stopped, the introduction of the combustion gas from the combustor 40 to the reformer 23 is stopped. In this manner, the startup control by the control unit 37 is ended.

The control unit 37 may adjust the opening degree of the main throttle valve 15 and change the injection timing of the main injector 14 from when the startup control ends to when the ammonia engine 11 is stopped. The control unit 37 may adjust the amount of air introduced into the reformer 23 from the first air passage 24a by adjusting the opening degree of the first throttle valve 26. The control unit 37 may change the injection timing of the first injector 25.

The control unit 37 executes stop control to stop the ammonia engine 11. The control unit 37 performs the stop control on condition that it is determined that the ignition switch 36 has been turned off based on the operation signal from the ignition switch 36.

In the stop control, the control unit 37 stops the injection of ammonia gas from the main injector 14 and the first injector 25. In the stop control, the control unit 37 closes the main throttle valve 15, the first throttle valve 26, and the stop valve 33. Thus, the ammonia engine 11 is stopped.

### Combustion Reaction in Reformer

Air and ammonia gas are introduced into the reformer 23 from the first air passage 24a, and combustion gas is introduced into the reformer 23 from the combustor 40. The reforming catalyst 23b is warmed up by the combustion gas. As a result, an ammonia combustion reaction occurs in the reformer 23, where the ammonia gas chemically reacts with oxygen from the air, as represented by the following Expression (1).

$${NH}_{3} + 3 / 4 {O}_{2} \to 3 / 2 {H}_{2} O + 1 / 2 {N}_{2} + Q \qquad ( Expression 1 )$$

By the combustion reaction of ammonia, the reformer 23 generates a gas mixture containing moisture (H₂O) and nitrogen gas (N₂). The temperature of the reformer 23 is increased by the combustion heat generated by the combustion reaction of ammonia.

### Reforming Reaction in Reformer

When the temperature of the reformer 23 reaches a temperature at which reforming is possible, the reforming catalyst 23b starts reforming ammonia gas. The temperature at which reforming is possible is, for example, about 300° C. to 400° C. During ammonia gas reforming, for example, a reforming reaction occurs in the reformer 23, where ammonia is decomposed into hydrogen (H₂) and nitrogen by combustion heat, as represented by the following Expression 2.

$${NH}_{3} \to 3 / 2 {H}_{2} + 1 / 2 {N}_{2} - Q \qquad ( Expression 2 )$$

By the reforming reaction, the reformer 23 generates reformed gas containing hydrogen and nitrogen. The reformed gas is discharged out of the reforming catalyst 23b. That is, the hydrogen gas contained in the reformed gas is discharged out of the reforming catalyst 23b. The reformed gas is introduced from the reformer 23 into the reformed gas passage 31, and then introduced into the intake passage 12 through the reformed gas passage 31.

### Supply of Reformed Gas to Combustion Chamber

The reformed gas introduced into the intake passage 12 from the reformed gas passage 31 is supplied to the combustion chamber 11a of the ammonia engine 11 from the intake passage 12. That is, the ammonia engine 11 is supplied with the hydrogen gas discharged out of the reforming catalyst 23b. The reformed gas is supplied to the combustion chamber 11a, together with the ammonia gas supplied from the main injector 14 to the intake passage 12 and the air in the intake passage 12. The ammonia gas and the hydrogen gas in the reformed gas are mixed in the combustion chamber 11a, making it easier for the ammonia gas to burn in the combustion chamber 11a. In the combustion chamber 11a, the ammonia gas burns together with the hydrogen gas in the reformed gas. After the startup control is started by the control unit 37, the ammonia gas burns together with the hydrogen gas in the combustion chamber 11a, thereby starting the ammonia engine 11.

### Details of Combustor

As shown in FIG. 2, the combustor 40 includes a tubular housing 41. The housing 41 has a first end 41a, which is open. The housing 41 has a second end 41b with a closing wall 42. The closing wall 42 is, for example, disk-shaped. The closing wall 42 closes the second end 41b of the housing 41. Thus, the second end 41b of the housing 41 is closed. The housing 41 and the closing wall 42 are made of a conductive metal material. The conductive metal material is, for example, stainless steel.

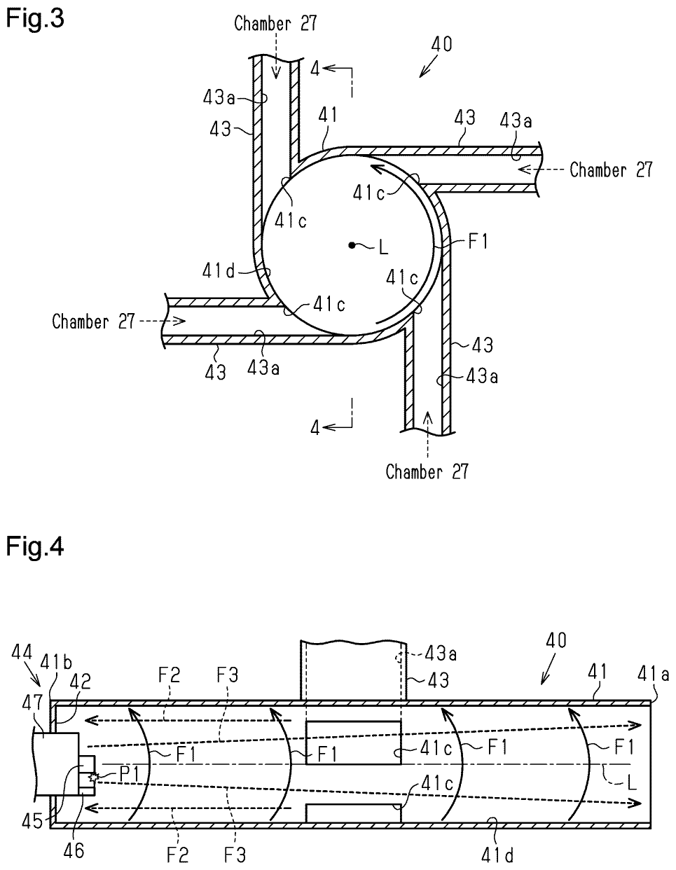

As shown in FIG. 3, the combustor 40 has four inlets 43. Each inlet 43 has, for example, a tubular shape and includes a passage 43a. One end of the inlet 43 is connected to the chamber 27. The other end of the inlet 43 is connected to the housing 41. In the cross-section orthogonal to an axis L of the housing 41, each of the four inlets 43 is connected to the housing 41 such that the passage 43a extends in the tangent direction of an inner circumferential surface 41d of the housing 41. The inlet 43 may be formed integrally with the housing 41. The inlet 43 may be formed separately from the housing 41 and fixed to the housing 41.

The passage 43a of each inlet 43 is connected to the interior of the housing 41 through an inlet hole 41c in the housing 41. The housing 41 includes four inlet holes 41c. Each inlet hole 41c is located, for example, at an intermediate portion of the housing 41 in the direction in which the axis L of the housing 41 extends. The four inlet holes 41c are separated from each other at equal intervals in the circumferential direction of the housing 41.

The ammonia gas mixed with air is introduced from the interior of the chamber 27 into the passage 43a of the inlet 43. The ammonia gas mixed with the air flows through the passage 43a and is then introduced into the housing 41 from the passage 43a. Thus, the inlets 43 introduce the ammonia gas as the fuel and the air as the oxidizing gas into the housing 41. The inlets 43 are each connected to the housing 41 such that the passage 43a extends in the tangent direction of the inner circumferential surface 41d of the housing 41. Thus, the ammonia gas and air introduced into the housing 41 from the inlet 43 flow in the circumferential direction of the housing 41 along the inner circumferential surface 41d of the housing 41.

As shown in FIG. 2, the combustor 40 includes an ignition plug 44. The ignition plug 44 is located at the second end 41b in the housing 41. The ignition plug 44 includes a positive electrode 45 and a negative electrode 46. The positive electrode 45 and the negative electrode 46 are separated from each other in the radial direction of the housing 41. For example, the positive electrode 45 is attached to the housing 41 by an insulating member 47 so as to extend through the closing wall 42. The insulating member 47 is made of an insulating material having pressure resistance and heat resistance, such as ceramic.

The positive electrode 45 and the negative electrode 46 have, for example, a columnar shape and extend in the direction in which the axis L of the housing 41 extends. The positive electrode 45 has a tip 45a that is located in the housing 41 in the direction in which the axis L of the housing 41 extends. Specifically, in the direction in which the axis L of the housing 41 extends, part of the positive electrode 45 including the tip 45a is located inside the housing 41, and the other part of the positive electrode 45 is located outside the housing 41. In the direction in which the axis L of the housing 41 extends, the tip 45a of the positive electrode 45 is located between the inlet holes 41c of the housing 41 and the closing wall 42.

In the housing 41, the positive electrode 45 is located, for example, on the axis L of the housing 41. The negative electrode 46 is located inside the housing 41, for example, at a position shifted from the axis L of the housing 41 in the radial direction of the housing 41 and separated from the inner circumferential surface 41d of the housing 41.

The combustor 40 includes an ignition unit 51. The ignition unit 51 includes an igniter 52 and a power supply 53. The power supply 53 selectively turns on and off the igniter 52. The on-off operation of the igniter 52 by the power supply 53 may be controlled by the control unit 37. In the startup control, the igniter 52 may be turned on by the power supply 53. The igniter 52 is connected to the positive electrode 45 via an electric wire 54. The igniter 52 supplies a pulse voltage to the positive electrode 45 via the electric wire 54.

### Flow of Ammonia Gas and Air in the Combustor

As shown in FIG. 4, the ammonia gas and air introduced into the housing 41 from the inlet 43 flow in the circumferential direction of the housing 41 along the inner circumferential surface 41d of the housing 41. As a result, a tubular flow F1 of the ammonia gas mixed with the air is generated in the housing 41. In other words, the inlet 43 introduces the ammonia gas and air into the housing 41 such that the tubular flow F1 is generated in the housing 41. The ammonia gas mixed with the air flows through the housing 41.

The ammonia gas and air flow from the opening of the inlet hole 41c, in the inner circumferential surface 41d, toward each of the first end 41a and the second end 41b of the housing 41 while flowing through the housing 41 so as to form the tubular flow F1. The flow of the ammonia gas and air from the opening of the inlet hole 41c, in the inner circumferential surface 41d, toward the second end 41b of the housing 41 is schematically represented as a gas flow F2 by the broken arrow in FIG. 4. The gas flow F2 is generated relatively near the inner circumferential surface 41d of the housing 41.

The ammonia gas and air that has flowed toward the second end 41b of the housing 41, as the gas flow F2, are turned back by the closing wall 42 and flow toward the first end 41a of the housing 41. The flow of the ammonia gas and air from the second end 41b toward the first end 41a of the housing 41 is schematically represented as a gas flow F3 by the broken arrow in FIG. 4. The gas flow F3 is generated at a central portion of the housing 41 in the radial direction of the housing 41.

### Negative Pressure Region

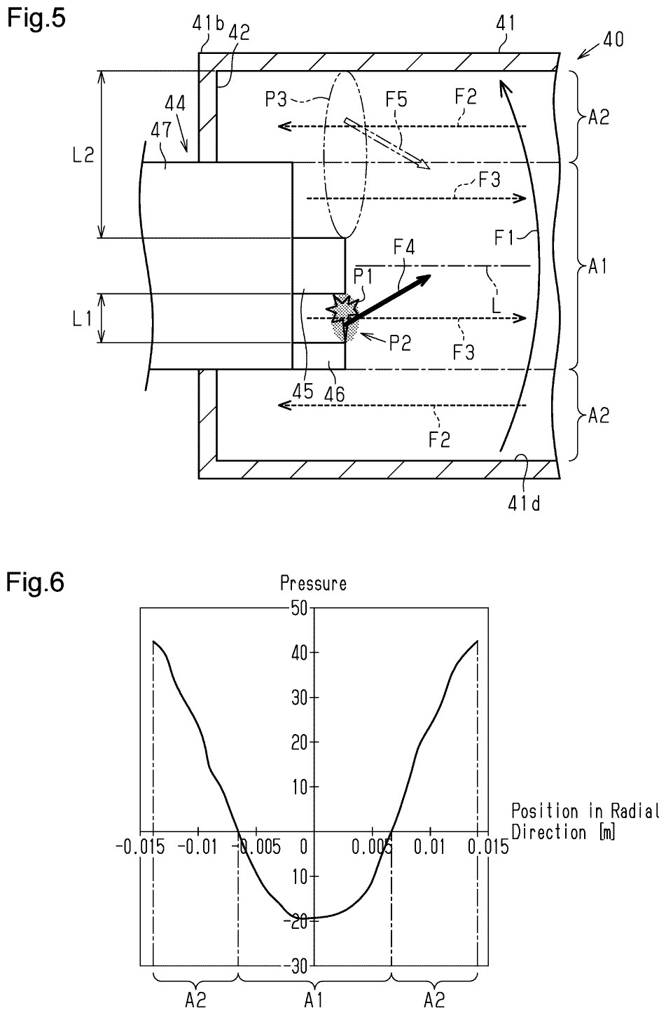

As shown in FIG. 5, a negative pressure region A1 is generated at a portion of the housing 41 of the combustor 40. The negative pressure region A1 is generated by the tubular flow F1 flowing along the inner circumferential surface 41d of the housing 41. In detail, the negative pressure region A1 includes the central portion of the housing 41 in the radial direction of the housing 41. For example, the axis L of the housing 41 is the center of the negative pressure in the negative pressure region Al. In the internal space of the housing 41, the region between the negative pressure region Al and the inner circumferential surface 41d of the housing 41 in the radial direction of the housing 41 is a positive pressure region A2.

FIG. 6 is a graph showing the relationship between the position of the housing 41 in the radial direction and the pressure in the housing 41. The horizontal axis of FIG. 6 indicates the position of the housing 41 in the radial direction in the cross-section of the housing 41 along the axis L. The position at which the numerical value on the horizontal axis is 0 is on the axis L of the housing 41. On the horizontal axis, the range larger than 0 indicates a position on one side of the axis L in the radial direction of the housing 41, and the range smaller than 0 indicates a position on the other side of the axis L in the radial direction of the housing 41. In the range larger than 0 on the horizontal axis, a larger numerical value on the horizontal axis indicates a position closer to the inner circumferential surface 41d of the housing 41. In the range smaller than 0 on the horizontal axis, a smaller numerical value on the horizontal axis indicates a position closer to the inner circumferential surface 41d of the housing 41. The vertical axis in FIG. 6 represents the pressure in the housing 41. On the vertical axis, the range larger than 0 indicates that the pressure in the housing 41 is a positive pressure, and the range smaller than 0 indicates that the pressure in the housing 41 is a negative pressure. As shown in FIG. 6, the central portion of the housing 41 in the radial direction has a negative pressure. Other portions of the housing 41 have a positive pressure. The graph of FIG. 6 reveals that the negative pressure region Al and the positive pressure

### Combustion of Ammonia Gas

As shown in FIGS. 2 and 4, when a relatively high voltage is applied from the igniter 52 to the positive electrode 45, discharge occurs between the positive electrode 45 and the negative electrode 46. As a result, a spark P1 is generated between the positive electrode 45 and the negative electrode 46. That is, the ignition unit 51 generates the spark P1 between the positive electrode 45 and the negative electrode 46. The spark P1 ignites the ammonia gas in the housing 41. The igniter 52 may be turned off by the power supply 53 at a time when the ammonia gas in the housing 41 is ignited.

As shown in FIG. 5, when the spark P1 ignites the ammonia gas, the ammonia gas burns so that a flame P2 is generated. The flame P2 is schematically shown with dot hatching in FIG. 5. The spark Pl generates the flame P2 between the positive electrode 45 and the negative electrode 46. The spark P1 is generated in a region where the positive electrode 45 and the negative electrode 46 are closest to each other. Thus, the flame P2 is also generated in a region where the positive electrode 45 and the negative electrode 46 are closest to each other. In the present embodiment, the region where the distance between the positive electrode 45 and the negative electrode 46 is the shortest is a region between the positive electrode 45 and the negative electrode 46 in the radial direction of the housing 41. When ammonia gas burns, combustion gas is generated in the housing 41. The combustion gas generated by combustion of ammonia gas as fuel flows through the housing 41. The combustion gas is introduced into the reformer 23 from the first end 41a of the housing 41.

The flame P2 immediately after the generation flows so as to approach the axis L of the housing 41, which is the center of the negative pressure in the negative pressure region A1, as a flame flow F4 indicated by the solid arrow in FIG. 5. Due to the gas flow F3 of the ammonia gas and air generated in the negative pressure region A1, the flame P2 grows from the second end 41b toward the first end 41a of the housing 41. The growth of the flame P2 promotes the generation of combustion gas resulting from the combustion of the ammonia gas in the housing 41. The flame P2 approaches the inner circumferential surface 41d of the housing 41 as it approaches the first end 41a of the housing 41. At a position relatively near the inner circumferential surface 41d of the housing 41, the flame P2 grows along the tubular flow F1 in the housing 41.

### Positions of the Positive Electrode and the Negative Electrode

The positive electrode 45 and the negative electrode 46 are disposed at such positions that a distance L1 between the positive electrode 45 and the negative electrode 46 is shorter than a distance L2 between the positive electrode 45 and the inner circumferential surface 41d of the housing 41. The distance L1 is the shortest distance between the positive electrode 45 and the negative electrode 46. The distance L2 is the shortest distance between the positive electrode 45 and the inner circumferential surface 41d of the housing 41. The distances L1 and L2 in the present embodiment are distances in the radial direction of the housing 41.

The discharge from the positive electrode 45 is performed on one of the negative electrode 46 and the inner circumferential surface 41d of the housing 41 that is closer to the positive electrode 45. The distance LI between the positive electrode 45 and the negative electrode 46 is shorter than the distance L2 between the positive electrode 45 and the inner circumferential surface 41d of the housing 41. Thus, discharge occurs between the positive electrode 45 and the negative electrode 46. Accordingly, the spark PI is generated between the positive electrode 45 and the negative electrode 46.

The positive electrode 45 and the negative electrode 46 are arranged such that the flame P2 generated between the positive electrode 45 and the negative electrode 46 by the spark PI is formed only in the negative pressure region Al. Specifically, within the region between the positive electrode 45 and the negative electrode 46, the generation region of the flame P2 with a width of the distance LI is located in the negative pressure region A1.

Relationship of the Distance between the Positive Electrode and the Negative

### Electrode with the Startup Time

As the distance LI between the positive electrode 45 and the negative electrode 46 increases, the size of the flame P2 immediately after the generation increases. Under the condition that the positive electrode 45 and the negative electrode 46 are disposed such that the flame P2 is formed only in the negative pressure region A1, the larger the size of the flame P2 immediately after generation, the earlier the flame P2 grows from the second end 41b to the first end 41a of the housing 41. This allows the combustor 40 to generate a large amount of combustion gas at an earlier stage.

Referring to FIG. 1, the reforming catalyst 23b is warmed up when the combustion gas, generated in the combustor 40, is introduced into the reformer 23. When the combustor 40 can generate a large amount of combustion gas at an earlier stage, the reforming catalyst 23b can be warmed up at an earlier stage. This allows the reformed gas containing hydrogen to be generated by the reformer 23 at an earlier stage. Further, since the reformed gas can be introduced into the combustion chamber 11a of the ammonia engine 11 from the reformer 23 through the reformed gas passage 31 and the intake passage 12 at an earlier stage, the ammonia engine 11 can be started at an earlier stage. As described above, under the condition that the positive electrode 45 and the negative electrode 46 are arranged such that the flame P2 is formed only in the negative pressure region Al, the longer the distance LI between the positive electrode 45 and the negative electrode 46, the shorter the startup time for the ammonia engine 11. The distance LI between the positive electrode 45 and the negative electrode 46 of the present embodiment allows the ammonia engine 11 to be started within a start time required for the vehicle 50, on which the ammonia engine system 10 is mounted. The distance LI between the positive electrode 45 and the negative electrode 46 is, for example, larger than the minimum distance required for the flame P2 to be generated by the ignition of the spark PI to the ammonia gas.

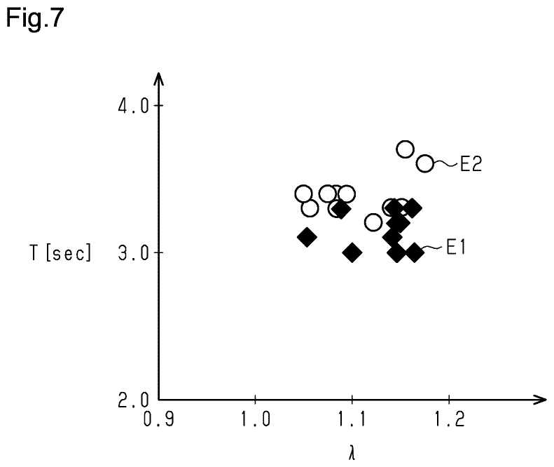

As shown in FIG. 7, a time T required to start the ammonia engine 11 was measured for Example, in which discharge was performed between the positive electrode 45 and the negative electrode 46, and Comparative Example, in which discharge was performed between the positive electrode 45 and the inner circumferential surface 41d of the housing 41. The time T is from when the ignition switch 36 is turned on to when the startup of the ammonia engine 11 is completed. The startup of the ammonia engine 11 is completed at the time when ammonia gas starts to burn together with hydrogen gas in the combustion chamber 11a. In this measurement, the distance L1 between the positive electrode 45 and the negative electrode 46 in Example was 5 mm, and the distance L2 between the positive electrode 45 and the inner circumferential surface 41d of the housing 41 in Comparative Example was 15 mm. The time T was measured a number of times in each of Example and Comparative Example under the condition that an excess air ratio λ was around 1.1. The excess air ratio λ is a value obtained by dividing the mass of air supplied by the theoretically required minimum air mass. In FIG. 7, the measurement value of Example is indicated by a point E1, and the measurement value of Comparative Example is indicated by a point E2. As indicated by the points E1 and E2, the time T in Example had a tendency to be shorter than the time T in Comparative Example. The experimental result reveals that the time T required to start the ammonia engine 11 was shorter in Example, in which discharge was performed between the positive electrode 45 and the negative electrode 46, than in Comparative Example, in which discharge was performed between the positive electrode 45 and the inner circumferential surface 41d of the housing 41.

### Operation

The operation of the present embodiment will now be described.

FIG. 5 shows, as Comparative Example, that discharge is performed between the positive electrode 45 and the inner circumferential surface 41d of the housing 41. As indicated by the long dashed double-short dashed line in FIG. 5, a flame P3 in Comparative Example is generated between the positive electrode 45 and the inner circumferential surface 41d of the housing 41. Thus, the flame P3 immediately after the generation in Comparative Example is formed in the negative pressure region A1 and the positive pressure region A2. A portion of the flame P3 formed in the positive pressure region A2 receives the gas flow F2, which is the flow of the ammonia gas and air relatively near the inner circumferential surface 41d of the housing 41 toward the second end 41b. The flame P3 in Comparative Example flows so as to approach the axis L of the housing 41, which is the center of the negative pressure in the negative pressure region A1, as indicated by a flame flow F5 indicated by the blank arrow of the long dashed double-short dashed line. Due to the gas flow F3 of the ammonia gas and air generated in the negative pressure region A1, the flame P3 grows from the second end 41b toward the first end 41a of the housing 41. However, since a portion of the flame P3 is affected by the gas flow F2 as described above, the flame P3 in Comparative Example is less likely to grow from the second end 41b toward the first end 41a of the housing 41.

In the present embodiment, the flame P2 is generated between the positive electrode 45 and the negative electrode 46. The flame P2 immediately after the generation flows so as to approach the axis L of the housing 41, which is the center of the negative pressure in the negative pressure region A1, as indicated by the flame flow F4. Due to the gas flow F3 of the ammonia gas and air generated in the negative pressure region A1, the flame P2 grows from the second end 41b toward the first end 41a of the housing 41. The positive electrode 45 and the negative electrode 46 are arranged such that the flame P2 generated between the positive electrode 45 and the negative electrode 46 by the spark PI is formed only in the negative pressure region A1. Thus, the flame P2 generated between the positive electrode 45 and the negative electrode 46 is less likely to be affected by the gas flow F2, which is the flow of the ammonia gas and air relatively near the inner circumferential surface 41d of the housing 41 toward the second end 41b. Accordingly, the flame P2 generated in the present embodiment is more likely to grow from the second end 41b toward the first end 41a of the housing 41 than the flame P3 generated in Comparative Example.

### Advantages

The above-described embodiment has the following advantages.
(1) The positive electrode 45 and the negative electrode 46 are arranged such that the flame P2 generated between the positive electrode 45 and the negative electrode 46 by the spark P1 is formed only in the negative pressure region A1. Thus, as compared to when the flame P3 is generated between the positive electrode 45 and the inner circumferential surface 41d of the housing 41, the flame P2 grows at an earlier stage from the second end 41b toward the first end 41a of the housing 41. This allows the combustor 40 to generate a large amount of combustion gas at an earlier stage.
(2) The reforming catalyst 23b is warmed up by the combustion gas generated in the combustor 40. When the combustor 40 generates a large amount of combustion gas at an earlier stage, the reforming catalyst 23b can be warmed up at an earlier stage. This allows the reforming catalyst 23b to generate hydrogen at an earlier stage. Further, since hydrogen can be discharged out of the reforming catalyst 23b to the ammonia engine 11 at an earlier stage, the ammonia engine 11 can be started at an earlier stage.

### Modifications

The above-described embodiment may be modified as follows. The above-described embodiment and the following modifications can be combined if the combined modifications remain technically consistent with each other.

The distance L1 between the positive electrode 45 and the negative electrode 46 may be equal to the minimum distance required for the flame P2 to be generated in association with the ignition of the spark PI to the ammonia gas.

The positive electrode 45 and the negative electrode 46 may be spaced apart from each other in a direction intersecting the radial direction of the housing 41. In this case, the flame P2 may be generated between the positive electrode 45 and the negative electrode 46 in the direction intersecting the radial direction of the housing 41. As is the case in the above-described embodiment, the positive electrode 45 and the negative electrode 46 are disposed such that the flame P2 generated between the positive electrode 45 and the negative electrode 46 is formed only in the negative pressure region A1.

The position of the positive electrode 45 in the housing 41 may be shifted from the axis L of the housing 41. That is, as long as the positive electrode 45 and the negative electrode 46 are disposed such that the flame P2 generated between the positive electrode 45 and the negative electrode 46 is formed only in the negative pressure region A1, the positions of the positive electrode 45 and the negative electrode 46 may be changed in the housing 41.

The inlets 43 do not have to introduce ammonia gas mixed with air into the housing 41. For example, some of the inlets 43 may introduce only ammonia gas into the housing 41, and the other inlets 43 may introduce only air into the housing 41. That is, the inlets 43 only need to introduce the ammonia gas and air into the housing 41 such that the tubular flow F1 is generated in the housing 41.

The number of the inlets 43 of the combustor 40 may be three or less or may be five or more. That is, the combustor 40 may have at least one inlet 43. The phrase “at least one of” as used in this description means “one or more” of a desired choice. For example, the phrase “at least one of” as used in this description means “only one choice” or “both of two choices” if the number of choices is two. In another example, the phrase “at least one of” as used in this description means “only one single choice” or “any combination of two or more choices” if the number of its choices is three or more.

The main injector 14 may directly inject ammonia gas into the combustion chamber 11a.

The combustor 40 and the ammonia engine system 10 may use fuel other than ammonia gas. For example. the combustor 40 and the ammonia engine system 10 may use. for example. hydrocarbon gas or the like as fuel.

The combustor 40 and the ammonia engine system 10 may use oxygen as oxidizing gas.

The ammonia engine system 10 may also be employed in the hybrid vehicle 50.

1. A combustor, comprising:
a cylindrical housing having a first end and a second end, the first end being open and the second end being closed, and the housing being configured such that fuel mixed with oxidizing gas and combustion gas generated by combustion of the fuel flow through the housing;
at least one inlet configured to introduce the fuel and the oxidizing gas into the housing such that a tubular flow is generated in the housing, the inlet being configured such that the tubular flow generates a negative pressure region in part of the housing;
an ignition plug disposed at the second end of the housing and including a positive electrode and a negative electrode; and
an ignition unit configured to generate a spark between the positive electrode and the negative electrode, wherein
the positive electrode and the negative electrode are each located at a position where a distance between the positive electrode and the negative electrode is shorter than a distance between the positive electrode and an inner circumferential surface of the housing such that a flame generated between the positive electrode and the negative electrode by the spark is formed only in the negative pressure region.

2. An ammonia engine system, comprising:
the combustor according to claim 1;
a reforming catalyst configured to be warmed up by combustion gas; and
an ammonia engine configured to be supplied with hydrogen that is discharged out of the reforming catalyst, wherein
a distance between the positive electrode and the negative electrode allows the ammonia engine to be started within a start time required for a vehicle on which the ammonia engine system is mounted.
